(19) United States
(12) Patent Application Publication
(10) Pub. No.: US 2014/0203790 A1
(43) Pub. Date: Jul. 24, 2014

(54) Hybrid Continuous and Discontinuous Mode Operation

(71) Applicant: FAIRCHILD SEMICONDUCTOR CORPORATION, San Jose, CA (US)

(72) Inventors: Shangyang Xiao, Daly City, CA (US); Faisal Ahmad, San Jose, CA (US)

(73) Assignee: FAIRCHILD SEMICONDUCTOR CORPORATION, San Jose, CA (US)

(21) Appl. No.: 13/747,517

(22) Filed: Jan. 23, 2013

(51) Int. Cl. G05F 1/62

(52) U.S. Cl. CPC G05F 1/62
USPC 323/271

(57) ABSTRACT

This disclosure is directed to hybrid continuous and discontinuous mode operation. In general, a system comprising a control module and voltage converter module may be configured to operate in a continuous conduction mode (CCM) until a current through an inductor in the voltage converter module is determined to be at or below zero (e.g., negative). The controller may then transition to operating the voltage converter module in a discontinuous control mode (DCM). Some or all of the DCM may be implemented digitally within the controller. In this manner, benefits may be realized from operating in either CCM or DCM while minimizing the disadvantages associated with these control schemes. Moreover, digitizing DCM control may allow for easier implementation and better performance than traditional DCM operation.

### TECHNICAL FIELD

The present disclosure relates to power supplies, and more particularly, to digital power supply systems capable of operating in either a continuous or a discontinuous conduction mode.

### BACKGROUND

Synchronous buck converters may operate in both continuous conduction mode (CCM) and discontinuous conduction mode (DCM) depending on the power demands of the load. For example, the condition of the load may vary such that the load may draw less current, the output voltage of the converter may be changed, etc., which may cause the synchronous buck converter to begin to sink current from a load capacitor and temporarily operate in “boost” mode. In such a state, current through an output inductor may be negative, which may cause a negative current flow (e.g., drain to source current) through a low-side switching transistor of the power supply. In CCM operation the inductor current is allowed to go negative by continuously maintaining conduction through the low-side switching transistor. In DCM operation the low-side transistor is turned off periodically to prevent the negative current. Advantages and disadvantages exist in both CCM and DCM operation, making neither solution applicable to all possible situations.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example system configured for hybrid continuous and discontinuous mode operation in accordance with at least one embodiment of the present disclosure;

FIG. 2 illustrates example circuitry configured for hybrid continuous and discontinuous mode operation in accordance with at least one embodiment of the present disclosure;

FIG. 3 illustrates an example relationship between continuous and discontinuous mode waveforms in accordance with at least one embodiment of the present disclosure;

FIG. 4 illustrates an example transition between continuous and discontinuous mode operation in accordance with at least one embodiment of the present disclosure; and

FIG. 5 illustrates example operations for hybrid continuous and discontinuous mode operation in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure is directed to hybrid continuous and discontinuous mode operation. In general, a system comprising a control module and voltage converter module may be configured to operate in a continuous conduction mode (CCM) until a current through an inductor in the voltage converter module is determined to be at or below zero (e.g., negative). The control module may then transition to operating the voltage converter module in a digital discontinuous conduction mode (DCM). Some or all of the digital DCM may be implemented within the control module. In this manner, benefits may be realized from operating in CCM or DCM while minimizing the disadvantages associated with these control schemes. Moreover, digitizing DCM control allows for easier implementation and better performance than traditional DCM operation.

In one embodiment, an example system may comprise a voltage converter module, a zero current detection (ZCD) module and a control module. The voltage converter module may be to, for example, generate an output voltage and may include an inductor. The ZCD module may be to, for example, determine when a current through the inductor is at or below zero. The control module may be to, for example, operate the voltage converter module in the CCM until the ZCD module determines the inductor current is at or below zero and to operate the voltage converter module in a digital discontinuous conduction mode after the zero current detection module determines that the inductor current is at or below zero.

In one implementation, the voltage converter module may include a direct current (DC) to DC synchronous buck converter. For example, the voltage converter may also comprise a high-side transistor and a low-side transistor coupled to the inductor. An example ZCD module may comprise a comparator to output a signal to the control module when the inductor current is at or below zero, the state of the inductor current being sensed based on the comparator determining that a switching node voltage is above zero while the low-side transistor is on. The control module may also be to operate the voltage converter module in the DCM after the ZCD module determines that the inductor current is at or below zero. The digital DCM may comprise a control algorithm implemented by a controller in the control module, the control algorithm being to generate signals for driving the high-side transistor and low side transistor. In one embodiment, the control algorithm may not require inputs measured from the voltage converter module during operation to generate the drive signals. In the digital DCM the controller may also be to determine a transistor off-time for the high-side transistor based on a transistor on-time for the high-side transistor and a duty cycle for a signal driving the high-side transistor. In one embodiment, the high-side transistor off-time may be equal to the high-side transistor on time*(1−high-side transistor duty cycle)/high-side transistor duty cycle. An example method consistent with at least one embodiment of the present disclosure may include operating a voltage converter module in a continuous conduction mode, determining a current in an inductor in the voltage converter module, and transitioning to operating the voltage converter module in a digital DCM when the inductor current is determined to be at or below zero.

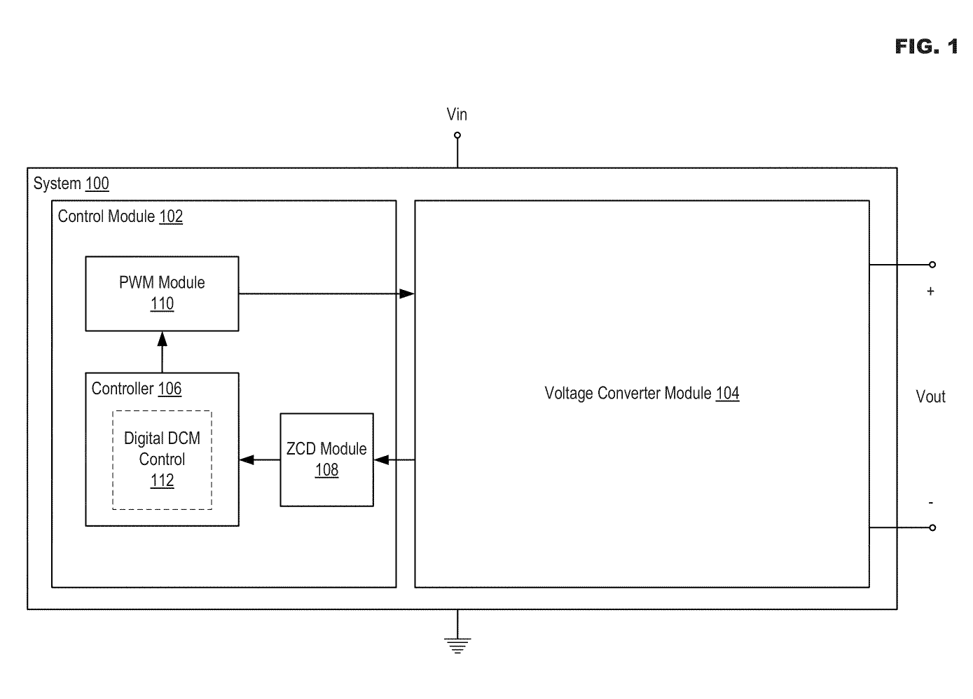

FIG. 1 illustrates an example system configured for hybrid continuous and discontinuous mode operation in accordance with at least one embodiment of the present disclosure. System 100 may comprise, for example, control module 102 and voltage converter module 104. It is important to note that in embodiments consistent with the present disclosure, the modules and/or other system elements discussed in regard to system 100 may reside, in whole or in part, within a single device such as, for example, an integrated circuit (IC), or alternatively, some or all of the modules/other system elements in system 100 may be discrete components, combinations of ICs and discrete components, etc. Control module 102 may control operation in voltage converter module 104 to generate an output voltage (e.g., Vout) based on an input voltage (e.g., Vin). For example, system 100 may be implemented in a mobile communication and/or computing device wherein a battery voltage (e.g., Vin) may be stepped down to a lower voltage (e.g., Vout) needed to drive components such as a processor and/or other integrated circuits (ICs) within the mobile communication and/or computing device.

Control module 102 may comprise, for example, a controller 106, a ZCD module 108 and a pulse width modulation (PWM) module 110. Controller 106 may also be configured to execute digital DCM control 112. In general, controller 106 may control PWM module 110 to generate signals for driving voltage converter module 104 in CCM. ZCD module may be coupled to voltage converter module 104, and may determine when a certain condition exists during the operation of voltage converter module 104 (e.g., when a current in an inductor within voltage converter module 104 is at or below zero). When the condition is determined to exist, ZCD module 108 may generate an output to controller 106 that may cause controller 106 to change from operating voltage converter module 104 in CCM to DCM using digital DCM control 112. The change in operational mode may be affected by, for example, changing how PWM module 110 generates the signals to drive voltage converter module 104. It is important to note that while controller 106, ZCD module 108 and PWM module 110 have been illustrated in FIG. 1 as separate modules in control module 102, it may also be possible for the functionality of one or both of ZCD module 108 and PWM module 100 to be incorporated within controller 106.

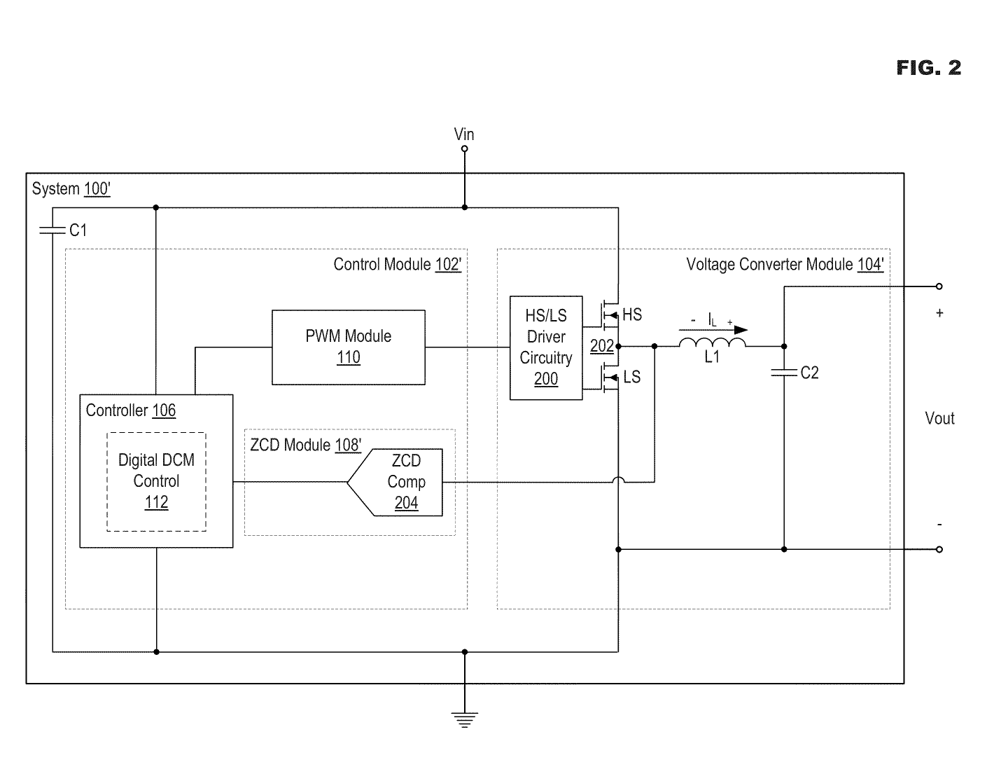

FIG. 2 illustrates example circuitry configured for hybrid continuous and discontinuous mode operation in accordance with at least one embodiment of the present disclosure. System 100′ may be composed in part or in whole of discrete devices, or alternatively, may be included within, or may form part of, a custom and/or general-purpose integrated circuit (IC) such as an application-specific integrated circuit (ASIC), a system-on-a-chip (SoC), a multi-chip module (MCM), etc. In the embodiment depicted in FIG. 1, system 100′ comprises a synchronous buck DC/DC converter configured to drive inductor circuitry to, for example, supply power to a load (not shown). Capacitor C1 may be configured across the input voltage to decouple Vin. Voltage converter module 104′ may comprise, for example, a high-side (HS) switch and a low-side (LS) switch, wherein the HS and LS switches may include transistors such as power MOSFETs. The HS and LS switches may also include, for example, body diode circuitry (not shown) and/or other well-known features of power supply switches. In one embodiment, the HS switch may be coupled to input voltage Vin and inductor L1, while the LS switch may also be coupled to the same side of inductor L1 and ground. Voltage converter module 104′ may also include HS/LS driver circuitry 200 to drive the HS and LS switches. PWM signals may be generated by PWM module 110 to drive HS/LS driver circuitry 200 that may include well-known feedback control mechanisms to provide control over a duty cycle of the PWM signals. While not shown in FIG. 2, in some instances it may be desirable to implement current sensing circuitry in voltage converter module 104′ to determine the current flowing through inductor L1. Current sense circuitry may include, for example, a series-coupled resistor and capacitor (e.g., RC network) placed across inductor L1 to generate a measurable value corresponding to the current flowing through inductor L1. Capacitor C2 may be placed across the output voltage to decouple Vout.

When demanded by a load, a synchronous buck converter can operate to source power and to sink power (e.g., boost mode) by permitting the current through inductor L1 (e.g., I_{L}) to go negative by flowing back through the LS switch. For example, system 100′ may generate Vout with I_{L} remaining positive in both CCM and DCM operation. However, a change in the output voltage or the current drawn by the load may cause system 100′ to sink power from C3, and I_{L} may therefore be permitted to go negative in CCM operation for some or all of the PWM duty cycle (e.g., “boost” mode). During DCM operation, the LS switch may be turned off to prevent I_{L} from flowing backwards. There are advantages and disadvantages to both CCM and DCM operation. CCM operation is able to generate Vout with less noise than DCM operation when the load is drawing more current. However, at least one advantage that DCM operation has over CCM operation is that it is substantially more efficient when the load is drawing less current. As a result, it may be beneficial for system 100′ to be able to operate in both modes.

However, configuring system 100′ to operate in both CCM and DCM requires controller 106 be aware of when I_{L} is about to go negative (e.g., is at or below zero). This is the point when the current drawn by the load has dropped to the point that transitioning from CCM to DCM may be advantageous to improve overall system performance. In traditional power supply solutions, an analog or digital approach may be taken to ZCD. In the analog solution, system 100′ may further comprise ZCD module 108′ to determine when I_{L} is at or below zero (e.g., by sensing polarity changes at the node wherein the HS switch and LS switch are coupled to inductor L1, hereafter referred to as switching node 202). ZCD module 108′ may include at least hysteresis comparator circuitry 204. In one embodiment, ZCD module 108′ may also include latch circuitry (not shown). The latch circuitry may include, for example, flip-flop circuitry (e.g., D-type flip-flop circuitry, as shown). A signal indicative of I_{L} may be determined by coupling the positive input of hysteresis comparator circuitry 204 to the switch side of inductor L1. In one embodiment, the output of hysteresis comparator circuitry 204 may be used to clock the latch circuitry, and a D input of the latch circuitry may be coupled to a Vin. The signal received from the switch side of inductor L1 may be relatively noisy, and thus, using latch circuitry may avoid “chatter” at the output of hysteresis comparator circuitry 204. ZCD module 108′ may generate a control signal indicative of the zero crossing of I_{L}. Hold circuitry (not shown) may also be employed at the output of hysteresis comparator circuitry 204 to hold the state of the control signal through one or more PWM cycles (e.g., to ensure controller 106 does not miss a zero crossing control signal). Example hold circuitry may comprise latching circuitry (e.g., D-type flip-flop devices, etc.) configured to latch the state of control signal.

While basically functional, certain operational characteristics in the analog solution may make it problematic for continual ZCD. Offset and delay inherent to the comparator may affect the accuracy, responsiveness, etc. of ZCD. Inaccuracy in ZCD may cause remaining current in inductor L1 to dissipate throughout voltage converter module 104′ and compromise efficiency. Excessive ringing may also result, causing electromagnetic interference (EMI) issues in system 100′. In the digital solution for ZCD, zero current may be determined by determining when the output current of system 100′ to drop below ½ (peak-to-peak ripple current of I_{L}). The peak-to-peak ripple current of I_{L} may be based on a relationship including Vin, Vout, the inductance of inductor L1, the switching frequency of the HS and LS switches and the output current. In this manner, ZCD may be determined digitally using parameters monitored from voltage converter module 104′. However, inductance may vary with current, temperature, etc. Vin, Vout and the switching frequency telemetry may also cause inaccuracy in the calculation of the peak-to-peak ripple current of I_{L}, which may affect the overall accuracy of ZCD. Inaccurate ZCD detection may compromise the efficiency of system 100′ and cause excessive ringing resulting in EMI.

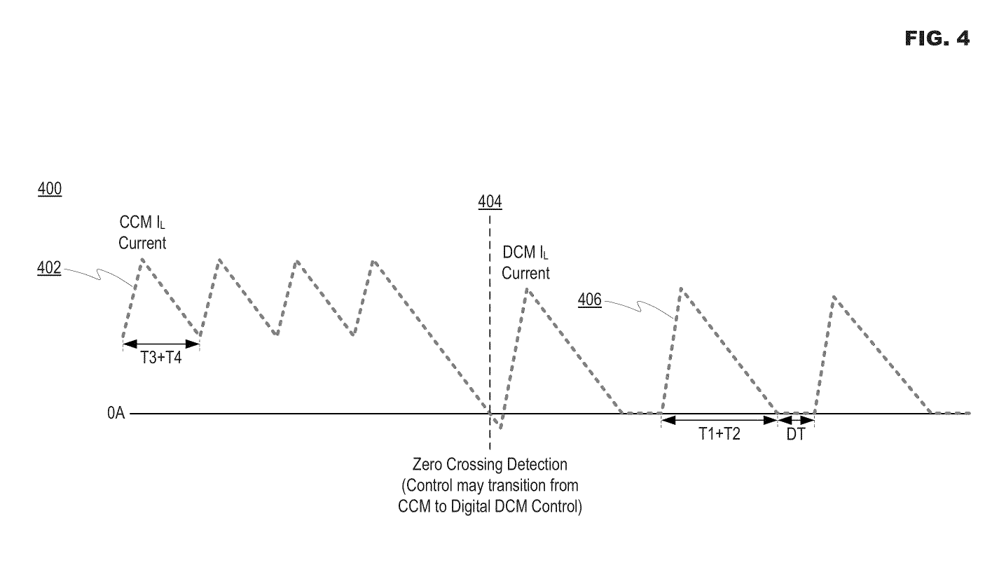

In one embodiment consistent with the present disclosure, a hybrid system may include analog features to initially a first zero crossing during CCM operation, but then all subsequent operation may be controlled digitally by controller 106. As illustrated by system 100′ in FIG. 4, ZCD module 108′ may be responsible for detecting the initial instance when I_{L} is at or below zero (e.g., based on ZCD comparator circuitry 204 sensing that the voltage at switching node 202 is above zero while the LS switch is on, which is indicative of I_{L} starting to reverse direction). After the initial ZCD, digital DCM control 112 may execute and algorithm to control generation of subsequent pulses (e.g., may control PWM signal generation by PWM 110). In this manner, the initial responsiveness of the analog solution may be leveraged without the negative aspects of continually relying upon analog ZCD. Substantially more efficient digital DCM control 112 may then take control of the operation of system 100′. However, in accordance with at least one embodiment, the digital control that may be employed to control system 100′ is significantly different than employed in existing solutions (e.g., without the requirement of providing values measured from voltage converter module 104′ as inputs to the digital DCM control algorithm).

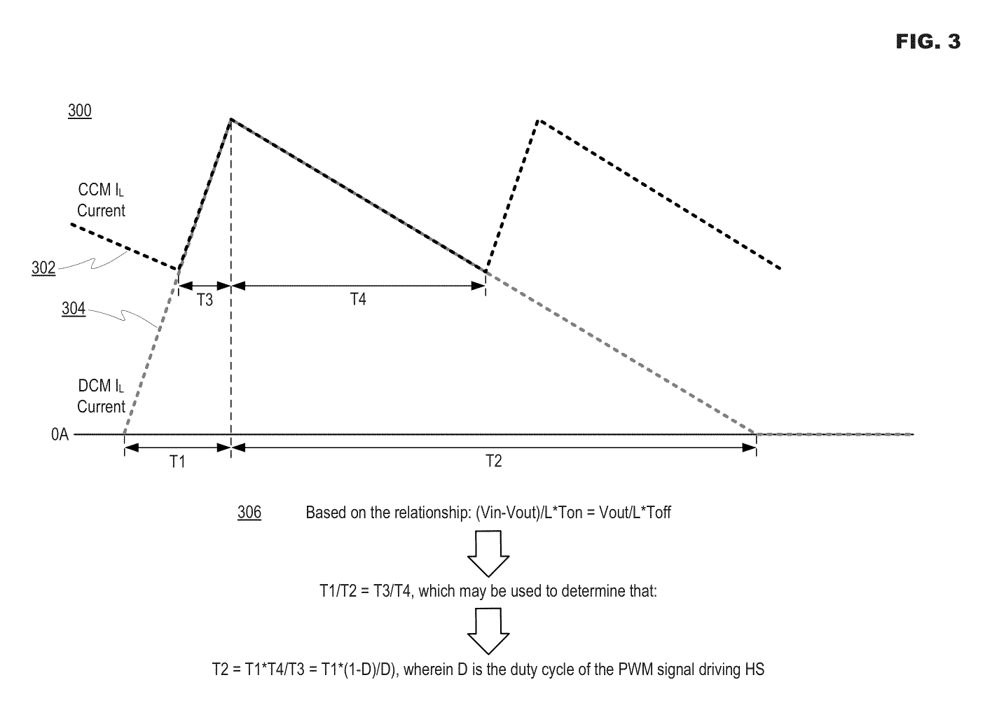

FIG. 3 illustrates an example relationship between continuous and discontinuous mode waveforms in accordance with at least one embodiment of the present disclosure. As shown in chart 300, the slope of I_{L} during CCM operation shown at 302 is substantially equal to the slope of I_{L} during DCM operation shown at 304. This relationship is also reflected in the equation:

$$\frac{Vin - Vout}{L} + {T}_{on} of HS switch = \frac{Vout}{L} * {T}_{off} of HS switch \qquad ( 1 )$$

Equation 1 represents the known proportionality of I_{L} with respect to the operation of the HS switch, wherein (Vin-Vout)/L is the slew rate of the upslope of I_{L} and Vout/L is the slope of the downside of I_{L}. In view of this relationship of slopes between the CCM I_{L} and DCM I_{L}:

$$\frac{T 1}{T 2} = \frac{T 3}{T 4} \qquad ( 2 )$$

Wherein T1 represents the on-time for the HS switch in DCM, T2 represents the off-time for the HS switch (e.g., and possibly the on-time for the LS switch) in DCM, T3 represents the on-time for the HS switch in CCM and T4 represents the off-time for the HS switch in CCM. Equation (2) may then be further manipulated to arrive at the following relationship:

$$\begin{matrix}T 2 = T 1 * \frac{T 4}{T 3} \\ = T 1 * \frac{( 1 - D )}{D}\end{matrix} \qquad ( 3 )$$

In equation (3), D is the duty cycle of the PWM signal that drives the HS switch. Equation (3) may allow digital DCM controller 112 to control DCM operation in system 100′ by predicting mathematically when I_{L} will approach zero without having to rely upon ZCD (e.g., using ZCD module 104). Equation (3) is more impervious to environmental influences than previous digital DCM strategies in that it does not rely upon as many parameters, and the parameters that are relied upon are not subject to environmental influence. T1 (e.g., the Tₒₙ time of the HS switch) and D (e.g., the duty cycle of the signal driving the HS switch) may be readily available to digital DCM control 112 via, for example, communication between controller 106 and voltage converter module 104′ as defined by the PMBUS specification or another standard that standardizes a manner in which to communicate with power converters over a digital bus. In one embodiment, the HS switch on-time to LS switch on-time ratio may be constant. Therefore, operation of the LS switch may be controlled based on the calculation of on-time and off-time for the HS switch as set forth in equation (3).

FIG. 4 illustrates an example transition between continuous and discontinuous mode operation in accordance with at least one embodiment of the present disclosure. For example, System 100 may initially operate in CCM as shown at 402. As conditions change (e.g., the amount of current draw by the load drops), then ZCD may determine that I_{L} drops to and past zero as shown at 404. After ZCD at 404, digital DCM control 112 may control DCM operation in I_{L} as shown at 406. In one embodiment, the dead time (e.g., DT) illustrated in FIG. 4 (e.g., the time during which the LS switch is turned off), may be controlled by controller 106 and/or PWM module 110 as a function of Vout and lout (e.g., control schemes for determining and/or setting DT based on Vout are well-known).

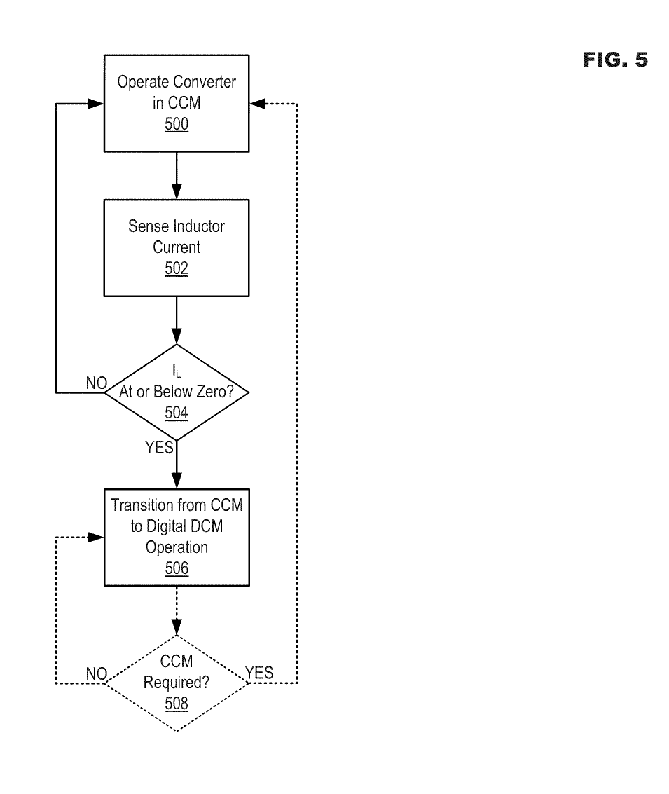

FIG. 5 illustrates example operations for hybrid continuous and discontinuous mode operation in accordance with at least one embodiment of the present disclosure. In operation 500 a voltage converter module may be operated in CCM. In operation 502 an inductor current may be sensed in the voltage converter module. For example, the inductor current may be sensed by a ZCD module coupled to the voltage converter module. A determination may then be made in operation 504 as to whether the inductor current I_{L} (e.g., as monitored by the ZCD module) is at or below zero. If it is determined in operation 504 that the inductor current I_{L} is above zero, then CCM operation may continue in operation 500. Otherwise, if it is determined that the inductor current I_{L} is at or below zero, then in operation 506 operation may be transitioned from CCM to digital DCM control.

Optionally (e.g., based on the system configuration), operation 506 may be followed by operation 508 wherein a further determination may be made as to whether to continue in DCM operation or return to CCM operation. In one embodiment, the determination may be based on the inductor current returning to a large positive value (e.g., current draw increasing in the load), which may be accompanied by a corresponding drop in the output voltage that may then trigger another PWM cycle. For example, if the output voltage of the voltage converter drops below the reference voltage (e.g., for setting the desired output voltage) prior to the expiration of the LS switch on-time, and this condition continues for a certain number of PWM cycles, the controller may then determine that the condition indicates that returning to CCM operation is appropriate. If it is determined in operation 508 that CCM is not required, then DCM operation may continue in operation 506. Otherwise, if it is determined that CCM is required, then operation 508 may be followed by a return to operation 500 wherein CCM operation may resume.

While FIG. 5 illustrates various operations according to an embodiment, it is to be understood that not all of the operations depicted in FIG. 5 are necessary for other embodiments. Indeed, it is fully contemplated herein that in other embodiments of the present disclosure, the operations depicted in FIG. 5, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, this disclosure is directed to hybrid continuous and discontinuous mode operation. In general, a system comprising a control module and voltage converter module may be configured to operate in a continuous conduction mode (CCM) until a current through an inductor in the voltage converter module is determined to be at or below zero (e.g., negative). The controller may then transition to operating the voltage converter module in a discontinuous control mode (DCM). Some or all of the DCM may be implemented digitally within the controller. In this manner, benefits may be realized from operating in either CCM or DCM while minimizing the disadvantages associated with these control schemes. Moreover, digitizing DCM control may allow for easier implementation and better performance than traditional DCM operation.

The following examples pertain to further embodiments. In one example there is provided a system. The system may include a voltage converter module including an inductor to generate an output voltage, a zero current detection module to determine when a current through the inductor is at or below zero, and a control module to operate the voltage converter module in a continuous conduction mode until the zero current detection module determines the inductor current is at or below zero.

In another example there is provided a method. The method may include operating a voltage converter module in a continuous conduction mode, determining a current in an inductor in the voltage converter module, and transitioning to operating the voltage converter module in a digital discontinuous conduction mode when the inductor current is determined to be at or below zero.

In another example there is provided at least one machine-readable storage medium. The at least one machine readable storage medium may have stored thereon, individually or in combination, instructions that when executed by one or more processors result in the following operations comprising operating a voltage converter module in a continuous conduction mode, determining a current in an inductor in the voltage converter module, and transitioning to operating the voltage converter module in a digital discontinuous conduction mode when the inductor current is determined to be at or below zero.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A system, comprising:
a voltage converter module including an inductor to generate an output voltage;
a zero current detection module to determine when a current through the inductor is at or below zero; and
a control module to operate the voltage converter module in a continuous conduction mode until the zero current detection module determines the inductor current is at or below zero and to operate the voltage converter module in a digital discontinuous conduction mode after the zero current detection module determines the inductor current is at or below zero.

2. The system of claim 1, wherein the voltage converter module includes a direct current (DC) to DC synchronous buck converter.

3. The device of claim 1, wherein the voltage converter module further comprises a high-side transistor and a low-side transistor coupled to the inductor.

4. The device of claim 3, wherein the zero current detection module comprises a comparator to output a signal to the control module when the inductor current is at or below zero, the state of the inductor current being sensed based on the comparator determining that a switching node voltage is above zero while the low-side transistor is on.

5. The device of claim 3, wherein the digital discontinuous conduction mode comprises a control algorithm implemented by a controller in the control module, the control algorithm being to generate signals for driving the high-side transistor and the low-side transistor.

6. The device of claim 5, wherein the control algorithm does not require inputs measured from the voltage converter module during operation to generate the drive signals.

7. The device of claim 5, wherein in generating the drive signals the controller is to determine a transistor off-time for the high-side transistor based on a transistor on-time for the high-side transistor and a duty cycle for the signal driving the high-side transistor.

8. The device of claim 7, wherein the high-side transistor off-time is equal to the high-side transistor on time*(1−high-side transistor duty cycle)/high-side transistor duty cycle.

9. A method, comprising:
operating a voltage converter module in a continuous conduction mode;
determining a current in an inductor in the voltage converter module; and
transitioning to operating the voltage converter module in a digital discontinuous conduction mode when the inductor current is determined to be at or below zero.

10. The method of claim 9, wherein the voltage converter module includes a direct current (DC) to DC synchronous buck converter.

11. The method of claim 9, wherein the digital discontinuous conduction mode comprises a control algorithm for generating signals for driving a high-side transistor and a low-side transistor in the voltage converter module.

12. The method of claim 11, wherein the control algorithm does not require inputs measured from the voltage converter module during operation to generate the drive signals.

13. The method of claim 11, wherein generating the drive signals comprises determining a transistor off-time for a high-side transistor based on a transistor on-time for a high-side transistor and a duty cycle for the signal driving the high-side transistor.

14. The method of claim 13, wherein the high-side transistor off-time is equal to the high-side transistor on time*(1−high-side transistor duty cycle)/high-side transistor duty cycle.

15. At least one machine-readable storage medium having stored thereon, individually or in combination, instructions that when executed by one or more processors result in the following operations comprising:
operating a voltage converter module in a continuous conduction mode;
determining a current in an inductor in the voltage converter module; and
transitioning to operating the voltage converter module in a digital discontinuous conduction mode when the inductor current is determined to be at or below zero.

16. The medium of claim 15, wherein the voltage converter module includes a direct current (DC) to DC synchronous buck converter.

17. The medium of claim 15, wherein the digital discontinuous conduction mode comprises a control algorithm for generating signals for driving a high-side transistor and a low-side transistor in the voltage converter module.

18. The medium of claim 17, wherein the control algorithm does not require inputs measured from the voltage converter module during operation to generate the drive signals.

19. The medium of claim 17, wherein generating the drive signals comprises determining a transistor off-time for a high-side transistor based on a transistor on-time for a high-side transistor and a duty cycle for the signal driving the high-side transistor.

20. The medium of claim 19, wherein the high-side transistor off-time is equal to the high-side transistor on time*(1−high-side transistor duty cycle)/high-side transistor duty cycle.
